(19) United States
(12) Patent Application Publication
(10) Pub. No.: US 2013/0166407 A1
(43) Pub. Date: Jun. 27, 2013

(54) COMPUTER IMPLEMENTED METHOD FOR MANAGING INFORMATION

(71) Applicant: Blendi Sullaj, St. Clair Shores, MI (US)

(72) Inventor: Blendi Sullaj, St. Clair Shores, MI (US)

(21) Appl. No.: 13/724,269

(22) Filed: Dec. 21, 2012

Related U.S. Application Data
(60) Provisional application No. 61/579,303, filed on Dec. 22, 2011.

(51) Int. Cl. G06Q 30/06

(52) U.S. Cl. CPC G06Q 30/0631
USPC 705/26.7

(57) ABSTRACT

A computer-implemented method for managing information used to control the serving of a set of one or more user content media components is provided. The information includes an array of links between user provided content over which the set of array of user provided content may be served. The links between user provided content is specified by a first user input and an accepted second user input. The system tracks a requester to a matcher and is formulated to assign points to the matcher for making a successful match for the requester.

### CROSS-REFERENCE TO RELATED APPLICATIONS

This application claims the benefit of U.S. Provisional Application No. 61/579,303, filed on Dec. 22, 2011. The entire disclosure of the above application is incorporated herein by reference.

### FIELD

The present disclosure relates to a computer implemented method of managing information and, more particularly, to a method for managing retail sales information.

### SUMMARY

This section provides a general summary of the disclosure, and is not a comprehensive disclosure of its full scope or all of its features. A computer-implemented method for managing information used to control the serving of a set of one or more user content media components is provided. The information includes an array of links between user provided content over which the set of array of user provided content may be served. The links between user provided content is specified by a first user input and an accepted second user input. The system tracks a requester to a matcher. It is formulated to assign points to the matcher for making a successful match for the requester. It is configured to assign points to the requester for making a purchase.

The computer-implemented method can include: a) accepting, by a computer system including at least one computer, a first array of user content media components; b) accepting, by a computer system including at least one computer, a first selection input for identifying at least a portion of the information; c) defining, by the computer system, an array of fashion images which is a subset of the first array of user content media components based on the first selection input; d) setting, by the computer system and responsive to the accepted array of fashion images input, a first indicator for the one or more user content media components associated with the portion of the information identified by the selection input; e) updating, by the computer system, the information based on the accepted selection input and the accepted array of fashion images input; f) storing, by the computer system, the updated information; g) determining, by the computer system, the existence of a review event; and h) reviewing, by the computer system, said array of fashion images, and associating one or more palette media components associated with a second array of fashion images such that the one or more palette media components within the array of fashion images form a third array of fashion images associated with the second array of fashion images.

According to another embodiment, an apparatus for managing information used to control the distribution of a set of one or more user content media components is provided. The information includes an array of links between user provided content. The links may include links between content specified by a first user input and an accepted second user input. The apparatus can include: a) at least one processor; b) an input for 1) accepting a selection input for identifying at least a portion of the information, and 2) accepting a first array of fashion images as an input, and c) at least one storage device storing program instructions which, when executed by the at least one processor, performs a method including 1) setting, responsive to the accepted a first array of fashion images as an input, a request indicator for the one or more user content media components associated with the portion of the information identified by the selection input; 2) updating the information based on the accepted selection input and the accepted request input; 3) storing the updated information; and 4) determining the existence of a review event.

According to another embodiment, a computer-implemented method for serving of a set of a plurality of user defined images of fashion components is provided. The user content media components include an array of user provided content. The computer-implemented method includes: a) accepting, by a computer system including at least one computer, a first array of defined images of fashion components; b) accepting, by a computer system including at least one computer, a first selection input for identifying at least a portion of the fashion components; c) defining, by the computer system, a second array of fashion images which is a subset of defined images of fashion components based on the first selection input; d) determining, by the computer system, the existence of a review event; and h) reviewing, by the computer system, said second array of fashion images, and associating one or more media components from a palette of media components associated with a third array of fashion images such that the one or the one or more of the palette of media components with the second array of fashion images, to form a fourth array of fashion images is associated with the second array of fashion images.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 represents a diagram of the system according to the present teachings; and

FIG. 2 represents a diagram of an alternate embodiment of the system.

Corresponding reference numerals indicate corresponding parts throughout the several views of the drawings.

### DETAILED DESCRIPTION

Example embodiments will now be described more fully with reference to the accompanying drawings.

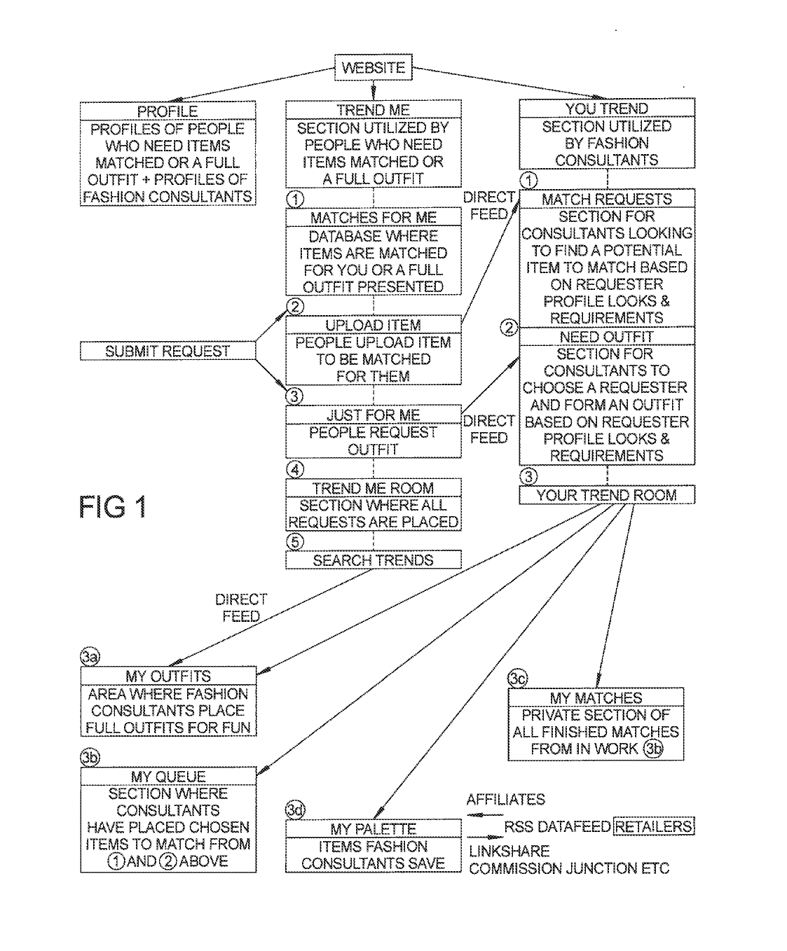

FIG. 1 represents a computer-implemented method for managing information used to control the distribution of a set of one or more user provided content media components. The information includes an array of links between elements of the user provided content. The links between user provided content can be specified by a first user input or an accepted second user input. The computer-implemented method begins in process block 10, accepting, by a computer system, a first array of user content media components. These components can be, for instance, images of fashion components owned or coveted by the user.

In process block 20, the system accepts by a computer system, including at least one computer, a first selection input for identifying at least a portion or subset of the information inputted at process block 10. For instance, this can be a subset of fashion components owned or desired by the user.

In process block 30, the system defines by the computer system a second array of fashion images which is a subset of the first array of user content media components based on the first selection input. The second array of images can be, for example, an “outfit.”

In process block 40, the system sets by the computer system and responsive to the accepted second array of fashion images input, a first indicator for the one or more user content media components associated with the portion of the information identified by the selection input. The first indicator can be, for instance, a request from the user to have the second array by another. Additionally, the request from the user for a recommendation for a fashion component.

In process block 50, the system updates by the computer system, the information based on the accepted selection input and the accepted second array of fashion images input. This information can be, for instance, a linked list of fashion components. In process block 60, the system stores by the computer system the updated information.

In process block 70, the system determines by the computer system, the existence of a review event. In process block 80, a second user uses the system to review by the computer system the second array of fashion images, and associates one or more palette media components associated with a third array of fashion images to the second array of fashion images. The one or the one or more palette of media components are associated with the second array of fashion images, to form a fourth array of fashion images associated with the second array of fashion images.

The review event can be a manual review input received after the setting of the first indicator. Optionally, the review event can be initiated by a request of a first user. In addition to the linked list, the information can include an advertisement. The information can be used to control the serving of the set of one or more user content media components. In this regard, the information can be organized in a hierarchical structure, where the selection input identifies at least a portion of the information by identifying a hierarchical level of the information. Updates to the hierarchical level identified propagate down to sub-components of the hierarchical level can be identified.

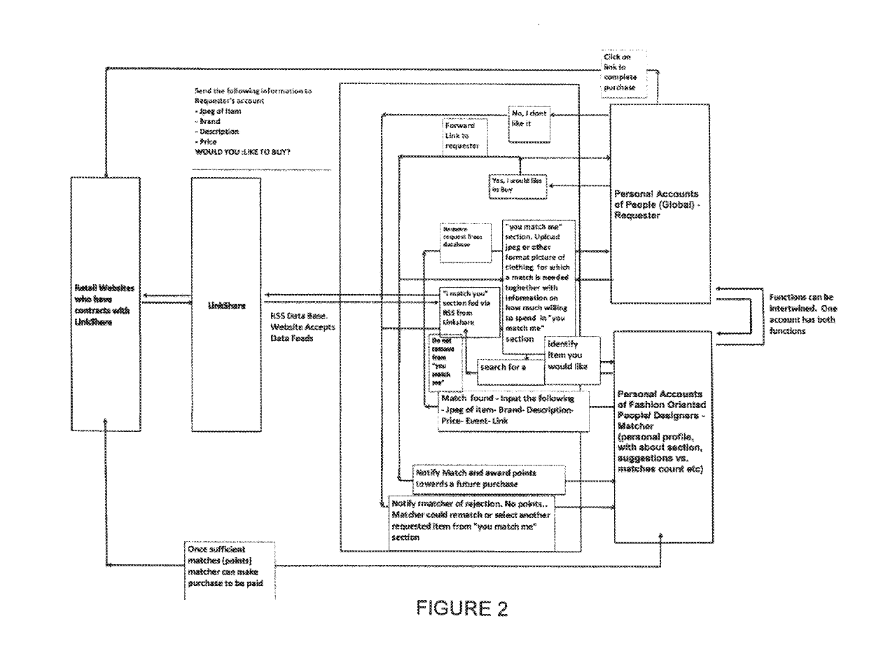

FIG. 2 represents an apparatus for managing information used to control serving of a set of one or more user content media components. The information includes an array of links between user provided content over which the set of array of user provided content may be served. The links between user provided content is specified by a first user input and an accepted second user input. The apparatus has at least one processor 100 having an input 110 for accepting a selection input 120 for identifying at least a portion of the information 124. The processor accepts a first array of fashion images 126 as a recursive input, and at least one storage device 128 for storing program instructions which when executed by the at least one processor. The processor 100 sets responsive to the accepted the first array of fashion images 126 as an input, a request indicator for the one or more user content media components associated with the portion of the information identified by the selection input. The system updates the information based on the accepted selection input and the accepted request input and stores the updated information.

The system determines the existence of a review event, and reviews by the computer system. A second array of fashion images formed of a first subset of the first array is formed. One or more palette media components associated with a third array of fashion images is provided such that the one or the one or more palette media components is associated with the second array of fashion images, to form a fourth array of fashion components.

The review event is a manual review input received after the system receives the first array of fashion images input when the review event has an expired time period tracked by a timer. Optionally, the system associates one or more palette media components with a third array of fashion images, and additionally associates an advertisement.

The system implements a method for serving of a set of user defined images of fashion components. The user content can be media components which include an array of user provided content, the computer-implemented method including:
a) accepting, by a computer system including at least one computer, a first array of defined images of fashion components;
b) accepting, by a computer system including at least one computer, a first selection input for identifying at least a portion of the information;
c) defining, by the computer system, a second array of fashion images which is a subset of defined images of fashion components based on the first selection input;
d) determining, by the computer system, the existence of a review event; and
h) reviewing, by the computer system, said second array of fashion images, and associating one or more media components from a palette of media components associated with a third array of fashion images, such that the one or the one or more of the palette of media components associated with the second array of fashion images forms a fourth array of fashion images is associated with the second array of fashion images.

The system shown in FIG. 2 has a first account for the first user. The first account is used by the user to upload the first array of user content. The user content can be an array of fashion images, or can be related to the user's wardrobe. The user can form a second array of images which is a subset of the first array of images. This second array, or a pointer thereto, can be forwarded to a “you match me” section of the system. A flag is set which is indicative of a request for a fashion match to the second array of images. Optionally, an indication of a fashion item can be set. For example, a request to “match a pair of shoes” or a blouse to the outfit can be made. This request is then sent to a request queue or array. The system also allows for a personal account for fashion oriented users or sales persons. These users can be designers or can be fashion enthusiasts. As described above, this can be the second user.

The second user can review the requests in the “you match me” section. Upon review, the second user can access a pallet of fashion components which can be associated retail sales cites. The system forwards the suggested image for a fashion component and link to the first user who is offered the option to purchase the object at a discounted price.

In the event the first user is interested in purchasing the object, the user clicks on the link to a web sales service which will offer the product to the first user. Encoded in the link is the identity of the first and second users. This will allow the secure user to receive attribution for the sale. The retail outlet will forward information to the link share organization. At this point, link share will pay the website.

Once a user picks an item to open, the user's picks are recorded and the information is directed to an intermediate web site or computer which manages the handling of the online transaction. The user preferences are captured in such a way that the user's ID, product ID, match ID if applicable, outfit ID if applicable, and timestamp are all tracked This intermediate computer then transfers the user to a retailer's page. Link is directed through the intermediate web site or computer providing a unique identifier to point to the user “click ID.” Purchase is made and commission data is sent back to the intermediate web site or computer referencing the provided “click ID.” Contemporaneously, or at a later time Commission data is pulled from intermediate web site or computer and is able to be matched via the “click ID.” Click ID is used to determine which user gets awarded points for purchasing, and which user (if any) gets points for providing the match/outfit or a portion of the commission.

Optionally, information associated with the fashion components can be an advertisement. The information used to control the serving of the set of one or more user content media components is organized in a hierarchical structure, wherein the selection input identifies at least a portion of the information by identifying a hierarchical level of the information, and wherein updates to the hierarchical level identified propagate down to sub-components of the hierarchical level identified. In this manner, fashion components can be prioritized.

Information for a specific user is located at the highest level of the hierarchy and can have associated thereto at least one ad campaign. Each of the ad campaigns can contain at least one ad group, wherein each of the ad groups contains at least one advertisement. A selection input related to a fashion components identifies at least portion of the information by identifying at least one of (a) the ad account, (b) one of the at least one ad campaigns, (c) one of the at least one ad groups, and (d) or e of the at least one user content media components.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

“As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor. The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.”

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A computer-implemented method for managing information used to control serving of a set of one or more user content media components, the information including an array of links between user provided content over which the set of array of user provided content may be served, wherein said links between user provided content is specified by a first user input and an accepted second user input, the computer-implemented method comprising:
a) accepting, by a computer system including at least one computer, a first array of user content media components;
b) accepting, by a computer system including at least one computer, a first selection input for identifying at least a portion of the information;
c) defining, by the computer system, a second array of fashion images which is a subset of the first array of user content media components based on the first selection input;
d) setting, by the computer system and responsive to the accepted a second array of fashion images input, a first indicator for the one or more user content media components associated with the portion of the information identified by the selection input;
e) updating, by the computer system, the information based on the accepted selection input and the accepted second array of fashion images input;
f) storing, by the computer system, the updated information;
g) determining, by the computer system, the existence of a review event; and
h) reviewing, by the computer system, said second array of fashion images, and associating one or more palette media components associated with a third array of fashion images such that the one or the one or more palette media components with the second array of fashion images, to form a fourth array of fashion images is associated with the second array of fashion images.

2. The computer-implemented method of claim 1 wherein the review event is a manual review input received after setting a first indicator.

3. The computer-implemented method of claim 1 wherein the review event is initiated by a request of a first user.

4. The computer-implemented method of claim 1 wherein the information is an advertisement, wherein the information used to control the serving of the set of one or more user content media components is organized in a hierarchical structure, wherein the selection input identifies at least a portion of the information by identifying a hierarchical level of the information, and wherein updates to the hierarchical level identified propagate down to sub-components of the hierarchical level identified.

5. The computer-implemented method of claim 4 wherein the account is located at the highest level of the hierarchy and contains at least one ad campaign, wherein each of the at least one ad campaigns contains at least one ad group, wherein each of the at least ad groups contains at least one advertisement, and wherein the selection input identifies at least portion of the information.

6. An apparatus for managing information used to control serving of a set of one or more user content media components, the information including an array of links between user provided content over which the set of array of user provided content may be served, wherein said links between user provided content is specified by a first user input and an accepted second user input, the apparatus comprising:
a) at least one processor module;
b) an input module for
1) accepting a selection input for identifying at least a portion of the information, and
2) accepting a first array of fashion images as an input; and
c) at least one storage device module storing program instructions which, when executed by the at least one processor, perform a method including
1) setting, responsive to the accepted the first array of fashion images as an input, a request indicator for the one or more user content media components associated with the portion of the information identified by the selection input,
2) updating the information based on the accepted selection input and the accepted request input,
3) storing the updated information,
4) determining the existence of a review event, and
5) reviewing, by the computer system, a second array of fashion images formed of a first subset of the first array, and associating one or more palette media components associated with a third array of fashion images such that the one or the one or more palette media components with the second array of fashion images, to form a with a fourth array of fashion is associated with the second array of fashion images.

7. The apparatus of claim 6 wherein the review event is a manual review input received after an earlier received a first array of fashion images input.

8. The apparatus of claim 6 wherein the review event has an expired time period tracked by a timer.

9. The apparatus of claim 6 wherein the associating one or more palette media components associated with a third array of fashion images is an advertisement, wherein the information used to control the serving of the set of one or more user content media components is organized in a hierarchical structure, wherein the selection input identifies at least a portion of the information by identifying a hierarchical level of the information, and wherein updates to the hierarchical level identified propagate down to sub-components of the hierarchical level identified.

10. A computer-implemented method for serving of a set of a plurality of user defined images of fashion components, the user content media components includes an array of user provided content, the computer-implemented method comprising:
a) accepting, by a computer system including at least one computer, a first array of defined images of fashion components;
b) accepting, by a computer system including at least one computer, a first selection input for identifying at least a portion of the information;
c) defining, by the computer system, a second array of fashion images which is a subset of defined images of fashion components based on the first selection input;
d) determining, by the computer system, the existence of a review event; and
h) reviewing, by the computer system, said second array of fashion images, and associating one or more media components from a palette of media components associated with a third array of fashion images such that the one or the one or more of the palette of media components with the second array of fashion images, to form a with a fourth array of fashion images is associated with the second array of fashion images.

11. The computer-implemented method of claim 10 wherein the review event is a manual review input received from a plurality of reviewers after setting a first indicator.

12. The computer-implemented method of claim 10 wherein the review event is initiated by a request of a first user.

13. The computer-implemented method of claim 10 wherein the information is a advertisement, wherein the information used to control the serving of the set of one or more user content media components is organized in a hierarchical structure, wherein the selection input identifies at least a portion of the information by identifying a hierarchical level of the information, and wherein updates to the hierarchical level identified propagate down to sub-components of the hierarchical level identified.

14. The computer-implemented method of claim 10 wherein associating one or more media components from a palette of media components associated with a third array of fashion images is associating images defined by a second user.
